(19) United States
(12) Patent Application Publication
(10) Pub. No.: US 2006/0134301 A1
(43) Pub. Date: Jun. 22, 2006

(54) Method for making a food composition with a preservative free enhancer and a food composition

(75) Inventor: Shi-Qiu Zhang, Tenafly, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America, Division of Conopco, Inc.

(21) Appl. No.: 11/019,561

(22) Filed: Dec. 22, 2004

(51) Int. Cl. A23L 2/00

(52) U.S. Cl. 426/590

(57) ABSTRACT

The present invention is directed to a method for making a food composition with a precursor and a preservative free food enhancing component. The method utilizes a precursor and a food enhancing component with an alkaloid additive and an alkaloid solubility enhancer in order to produce a high quality food composition having superior flavor.

### FIELD OF THE INVENTION

The present invention is directed to a method for making a food composition and the food composition prepared therefrom. More particularly, the present invention is directed to a food composition having an alkaloid and an alkaloid solubility enhancer added thereto. The food composition of this invention has improved flavor characteristics, a characteristic visual appearance, and does not have to be prepared with an enhancer containing traditional food-grade preservatives.

### BACKGROUND OF THE INVENTION

Excluding water, tea is the most popular beverage consumed by man. Tea is very refreshing, can be served either hot or cold, and has been made commercially available for many years. Lipton®, for example, is the world's leading brand of tea, made available in over 110 countries by Unilever.

Traditional food composition precursors, like tea concentrates that require water addition to produce a tea beverage, lose a portion of their alkaloids during the precursor preparation process. For example, when tea concentrates are prepared or manufactured, the same typically lose a portion of their caffeine during centrifugation and polishing operations.

The loss of alkaloids, like caffeine, in precursors usually results in the manufacture of food compositions, like tea compositions, with non-optimal flavor characteristics. Moreover, food compositions made with traditional food composition enhancers have conventional, yet often undesirable, preservatives present therein because the preservatives are required in the enhancers in order to ensure their microbiological stability.

It is of increasing interest to develop a method for making food compositions that have levels of alkaloids suitable to maximize flavor. It is also of increasing interest to develop food compositions that have limited preservatives since preservatives typically give off-flavors to the food compositions and are negatively perceived by those who are drawn to all natural and healthy foods. This invention, therefore, is directed to a method for making a food composition having an alkaloid additive and alkaloid solubility enhancer added thereto. The food composition of this invention has improved flavor characteristics, a characteristic visual appearance, and does not have to be prepared from a food enhancing component precursor containing traditional food-grade preservatives.

### ADDITIONAL INFORMATION

Efforts have been made for making tasty consumable compositions. In U.S. Application Publication No. 2003/0054089 A1, ready-to-eat and tasty foods are described.

Other efforts have been disclosed for making good tasting edible consumables. In U.S. Application Publication No. 2002/0001651 A1, edible consumables with monomeric or oligomeric polyphenolic compounds are described.

Even other efforts have been disclosed for making good tasting consumable compositions. In U.S. Pat. No. 6,413,570, concentrates for good tasting ready-to-drink tea compositions are described.

None of the additional information above describes a food composition comprising an alkaloid additive and an alkaloid solubility enhancer. Moreover, none of the additional information above describes a food composition that has been made with a microbiologically stable food enhancing component substantially free, and preferably, free of preservatives.

### SUMMARY OF THE INVENTION

In a first aspect, the present invention is directed to a method for making a food composition comprising, in no particular order, the steps of:
(a) contacting a food precursor with liquid, food enhancing component, alkaloid additive and alkaloid solubility enhancer to produce a food composition; and
(b) recovering the food composition.

In a second aspect, the present invention is directed to the food composition made by the method of the first aspect of this invention.

Food composition is defined herein to mean a composition suitable for consumption by humans, and particularly, those food compositions that can be made by diluting a precursor with a liquid, like water. Food enhancing component is defined to mean any component that enhances the characteristics of a food composition, including aroma and flavor characteristics. Alkaloid additive means alkaloid added in addition to alkaloid present in the food precursor, including the addition of identical alkaloid already present in the food precursor. Alkaloid solubility enhancer means a component that may be used in the production of a food composition and that will increase the solubility of the alkaloid additive in water. Consumer acceptable microstability (determined by Statistical Sampling Plan developed by the International Commission of Microbiological Specifications for Foods and as carried out by FDA's protocol set out in the Bacteriological Analytical Manual) means having Aerobic, Yeast, Mold and Coliform Aerobic Plate Counts of less than about 10 cfu/g, as well as an E. Coli count (assessed on petrifilm) of less than 10 cfu/g. Substantially free of preservatives means less than about 0.03% by weight, and preferably, less than about 0.01% by weight based on total weight of the food enhancing component. Free of preservative means having no preservative.

### DETAILED DESCRIPTION OF THE PREFERRED EMBODIMENTS

There is no limitation with respect to the type of food composition that may be made via the method of this invention as long as the food composition can be prepared by contacting a precursor with a liquid, like water. Illustrative examples of the types of food compositions that may be made via the method of this invention include a beverage (like tea, coffee, or an energy drink), spread, sauce, dip, spoonable dressing, pourable dressing, ice cream, pasta composition, wheat-based composition (e.g., bread), meal supplement or replacement drink, or a meal supplement or replacement bar.

In a preferred embodiment, however, the food composition of this invention is a ready-to-drink tea beverage.

The food precursor, therefore, is preferably a tea concentrate, and most preferably, a black tea concentrate. Such a tea concentrate is made commercially available by Unilever under the Lipton Tea Brand. The precursor often has from about 5.0 to about 30.0% by weight tea solids and is combined with selected carbohydrates (e.g., high fructose corn syrup and/or corn syrup) in a ratio of 1.5 parts or more of carbohydrate to 1.0 part of tea solids. Such a precursor (i.e., one that is used to make a ready to drink tea beverage) is preferably thermally and/or aseptically packaged and typically has a pH from about 3.0 to about 6.0, and preferably, from about 4.0 to about 6.0, including all ranges subsumed therein.

The preferred food precursor which may be used in this invention is often prepared by first making a mixture of enzymes suitable to digest the cell walls of tea leaf. Tea leaf is added to the enzyme mixture with water and sent through an extractor to allow for enzyme solution and tea leaf contact time. The resulting leaf slurry is heated to a temperature from about 25° C. to about 980° C., yielding an aqueous tea leaf solution. The same is pasteurized and subjected to centrifugation and concentration in order to recover the desired food precursor. A more detailed description of the preparation of the food precursors employable in this invention is found in U.S. Pat. No. 6,413,570, the disclosure of which is incorporated herein by reference.

The resulting food precursor (e.g., tea concentrate) may, in conventional practice, then be diluted with a liquid, like water, to produce a consumable black tea composition. Such a consumable black tea composition is usually translucent, and free of precipitate. However, conventional black tea compositions are prepared from precursors that have at least about 30.0 to about 45.0% less alkaloid (i.e., about 120-130 ppm) when compared to a tea beverage made directly from tea leaf. The conventional compositions, therefore, does not possess maximum flavor notes.

The food enhancing component suitable for use in the invention enhances the aroma and/or flavor characteristics of the food composition. In a preferred embodiment, the food enhancing component comprises aroma and/or flavor compounds, and especially, tea aroma and tea flavor compounds. Such a composition of tea aroma and/or tea flavor compounds is complex and typically consists of at least 500 compounds (organic and inorganic) including hydrocarbons, aldehydes, alcohols, esters, ketones, lactones, phenols, acids, as well as nitrogen- and sulfur-containing compounds. A list of tea enhancing components may be found in “Tea Cultivation to Consumption”, Wilson and Clifford, Chapman Hall, London (1992), the disclosure of which is incorporated herein by reference. Moreover, the food enhancing component of this invention, surprisingly, can be made substantially free of, or preferably, free of traditional food-grade preservatives which typically detract from the flavor of conventional food compositions.

When the food enhancing component employed in the present invention is, for example, one which comprises aroma and/or flavor compounds isolated from tea, the enhancing component is prepared by making an aqueous slurry or viscous puree of tea leaf and water and subjecting the same to a spinning cone column, also known as a liquid-gas contacting column. Such a column is known for isolating aroma and flavor compounds whereby the column is a distillation or stripping column in which steam removes, under vacuum, volatile compounds from liquid or steam. The preferred columns are made commercially available from suppliers like ConeTech and Flavourtech. The desired food enhancing component employed in this invention is aqueous and often has about 200 to about 700 ppm, and preferably, from about 300 to about 500 ppm of aroma and/or flavor compounds present therein.

In the present invention, it is preferred that alkaloid additive and alkaloid solubility enhancer (both typically in powder form) are added directly to the food enhancing component. The alkaloid additive is limited only to the extent that the same may be used in a food composition suitable for human consumption. Such an alkaloid additive is often found in plants (i.e., a xanthine) whereby the preferred alkaloids suitable for use in this invention are 1,3,7-trimethyl xanthine(caffeine), 1,3-dimethyl xanthine(theophyline), 3,7-dimethyl xanthine(theobromine) or a mixture thereof. The most preferred alkaloid is caffeine, whereby the amount of alkaloid added to the food enhancing component (about 2.0 to about 4.0%, preferably about 2.75 to about 3.75% by weight of the food enhancing component) is such that the end use food composition has at least about 165 ppm and preferably, at least about 175 ppm, and most preferably, at least about 185 ppm to about 195 ppm alkaloid, in 500 milliliters of food composition.

The alkaloid solubility enhancer suitable for use in this invention is one which is employable in food compositions. Such an enhancer is one which can form a salt with alkaloid and also increase the solubility of the alkaloid in water to over 1.83%, and preferably, to at least about 2.0%, and most preferably, over 2.5%. The solubility enhancer typically employed is an acid like citric acid, salicylic acid, phosphoric acid, cinnamic acid or a mixture thereof whereby the solubility enhancer is usually present at about 1.5 to about 2.5% by weight of the food enhancing component. The preferred solubility enhancer used in this invention is, however, citric acid.

When formulating the food enhancing component of this invention, aroma or flavor compounds or both are combined with alkaloid and alkaloid solubility enhancer and thoroughly mixed. The resulting composition is the food enhancing component of this invention wherein the same can surprisingly be used to make a superior tasting food composition, like a tea composition. Such a superior tasting food composition may be made even though the food enhancing component is substantially free of or free of traditional food-grade preservatives.

It is within the scope of this invention to employ optional food precursor additives like a chelator, colorant, preservative (e.g., potassium sorbate, sodium benzoate), flavor, vitamin, sweetener, fruit juices, surfactant (like sorbitan monolaurate and sorbitan monopalmitate), acidulant and the like. When employed, such optional additives, collectively, make up less than about 15.0% by weight of the total weight of the food precursor.

An example of the type of dispenser suitable for use in this invention is one which combines food precursor with a liquid, like water, and food enhancing component in order to produce a ready to drink beverage, like a tea beverage. Such a dispenser typically combines about 0.15 to about 0.25 part of food enhancing component to about every 1.0 to about 2.0 parts of precursor and about 95 to about 100 parts by weight liquid in order to produce the desired consumable composition (typically dispensed at 500 milliliters). A more detailed description of the type of dispenser suitable for use in this invention is described, for example, in U.S. Pat. Nos. 6,792,847, and 6,685,059, and U.S. Patent Application No. 2003/0116025, the disclosures of which are incorporated herein by reference.

The following examples are provided to facilitate an understanding of the present invention. The examples are not intended to limit the scope of the claims.

### EXAMPLE 1

Food composition precursors (tea concentrate) having the following ingredients were made:

| Ingredient | Percent by Weight (%) |
|---|---|
| Black tea solids | 32.40 |
| Preservative | 0.20 |
| Color | 0.64 |
| Acidulant | 0.55 |
| Corn syrup (72%) | 40.71 |

Ready-to-drink tea food enhancing components made commercially available from Unilever were combined with 3.0% caffeine and 2.0% citric acid. No preservatives were added.

The food composition precursors and food enhancing components were individually packaged in commercially available packages and dispensed from an apparatus similar to the one described in U.S. Pat. No. 6,792,847. The resulting ready-to-drink black tea consumable compositions were made by combining and dispensing about 1.34 part precursor for about every 0.2 part food enhancing component and about every 100 parts of water.

### EXAMPLE 2

The ready-to-drink tea compositions of Example 1 were visually examined and tasted by skilled panelists. The results indicated that the ready-to-drink tea compositions of this invention, unexpectedly, had the characteristic look of a traditional ready-to-drink tea composition notwithstanding the fact that caffeine was added. Moreover, it was unexpectedly concluded, via taste panels conducted by the skilled panelists, that the ready-to-drink tea compositions of Example 1 had a residual bitterness, astringency and mouthfeel consistent with that of fresh brewed tea and better than commercially available ready-to-drink tea.

What is claimed is:

1. A method of making a food composition comprising, in no particular order, the steps of
(a) contacting a food precursor with liquid, food enhancing component, alkaloid additive and alkaloid solubility enhancer to produce a food composition; and
(b) recovering the food composition.

2. The method of making a food composition according to claim 1 wherein the alkaloid additive and alkaloid solubility enhancer are present in the food enhancing component.

3. The method of making a food composition according to claim 1 wherein the food precursor is a concentrate for a ready-to-drink tea beverage.

4. The method of making a food composition according to claim 1 wherein the food enhancing component comprises flavor compounds, aroma compounds or both flavor and aroma compounds.

5. The method of making a food composition according to claim 1 wherein the alkaloid additive is 1,3,7-trimethyl xanthine, 1,3-dimethyl xanthine, 3,7-dimethyl xanthine or a mixture thereof.

6. The method of making a food composition according to claim 1 wherein the alkaloid additive is 1,3,7-trimethyl xanthine.

7. The method of making a food composition according to claim 1 wherein the alkaloid solubility enhancer is citric acid, salicylic acid, phosphoric acid, cinnamic acid or a mixture thereof.

8. The method of making a food composition according to claim 1 wherein the alkaloid solubility enhancer is citric acid.

9. The method of making a food composition according to claim 1 wherein the food composition is a ready-to-drink tea beverage, the alkaloid additive is caffeine, and the alkaloid solubility enhancer is citric acid.

10. A ready-to-drink tea composition made by the method of claim 1.

11. A ready-to-drink coffee composition made by the method of claim 1.

12. A ready-to-drink energy drink composition made by the method of claim 1.
